(19) United States
(12) Patent Application Publication
(10) Pub. No.: US 2024/0375687 A1
(43) Pub. Date: Nov. 14, 2024

(54) AUTONOMOUS CONTAINER

(71) Applicant: Charles Thomas, Ashland, OR (US)

(72) Inventor: Charles Thomas, Ashland, OR (US)

(21) Appl. No.: 18/195,085

(22) Filed: May 9, 2023

(51) Int. Cl. B60W 60/00

(52) U.S. Cl. CPC B60W 60/00256; B60L 50/60; B60P 1/6418; B60W 2720/10; B60W 2720/24

(57) ABSTRACT

A modular autonomous container capable of delivering itself via a road system without the need of a semi-truck, trailer, or driver which is powered by rechargeable batteries which comprise of a shipping container, a 3-wheeler pallet, a 4-wheeler pallet, a rechargeable battery, a computing device, and a plurality of wheels.

### FIELD OF THE INVENTION

The present subject matter relates to an autonomous container that is capable of delivering itself to the desired location.

### BACKGROUND OF THE INVENTION

Most delivery mechanisms require a driver to transport pallets of goods or materials. What has been devised is a shipping container that is able to transport itself.

### PRIOR ART

Most pallet transportation systems require human input. In examples like U.S. Pat. No. 9,908,549 which do not require human input, the pallet jacks aren't modular and are not designed for long range transportation.

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

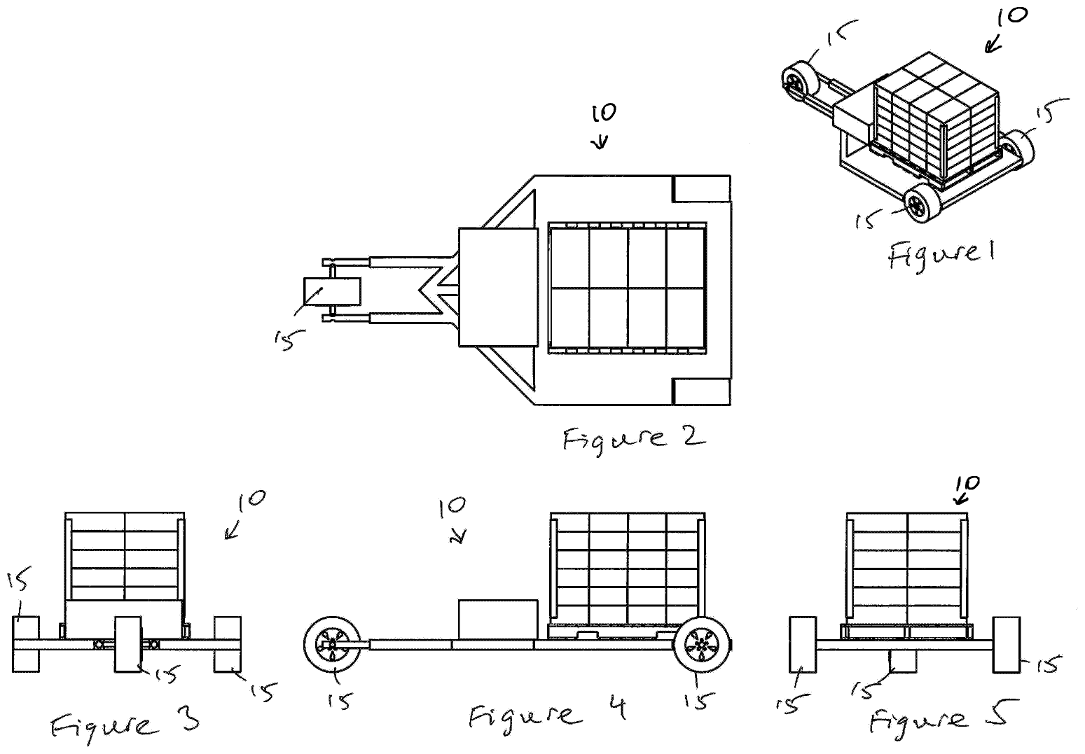

According to some embodiments, an autonomous container 10 is presently disclosed and shown in FIGS. 1-5. The presently disclosed container may be, for example, a shipping container, a 3-wheeler pallet, a 4-wheeler pallet, single pallet, and/or multiple pallets linked as a train.

The presently disclosed autonomous container 10 is capable of delivering itself via a road system without the need of a semi-truck and/or trailer, does not need a driver, is electrically powered with rechargeable batteries, is economically safe, reducing noise and other pollutants, can illuminate the need for distribution warehouses by delivering itself quickly and efficiently to the final destination using a modular concept which can scale for large loads.

According to some embodiments, the presently disclosed autonomous container 10 may comprise wheels 15 and one or more motors controlling the wheels.

The computing device may comprise more or fewer components than described below, may combine two or more components, or a may have a different configuration or arrangement of the components. The various components described below may be implemented in hardware, software or a combination of both hardware and software, including one or more signal processing and/or application specific integrated circuits.

According to some embodiments, the computing device may comprise a memory (which may comprise one or more computer readable storage mediums), one or more processing units (CPU's), an audio circuitry, a speaker, in accordance with some embodiments. These components may communicate over one or more communication buses or signal lines.

The memory may comprise high-speed random-access memory and/or non-volatile memory, such as one or more magnetic disk storage devices, flash memory devices, or other non-volatile solid-state memory devices. Access to memory by other components of the computing device, such as the CPU may be controlled by a memory controller.

The computing device and/or the chip(s) may comprise a radio frequency (RF) circuitry. The radio frequency (RF) circuitry may be configured to receive and transmit RF signals, also called electromagnetic signals. The RF circuitry converts electrical signals to/from electromagnetic signals and communicates with communications networks and other communications devices via the electromagnetic signals.

The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth.

The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication.

The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The computing device and/or the chip(s) may further comprise a power system for powering the various components. The power system may comprise a power management system, one or more power sources (e.g., battery, alternating current (AC)), a recharging system, a power failure detection circuit, a power converter or inverter, a power status indicator (e.g., a light-emitting diode (LED)) and/or any other components associated with the generation, management and distribution of power.

The chip(s) may further comprise GPS module (or sets of instructions). The GPS module determines the location of the chip(s) and provide this information to the computing device using, for example, the radio frequency (RF) circuitry.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation.

The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom.

Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable.

Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

### DETAILED DESCRIPTION OF THE INVENTION

FIG. 1 shows a perspective view of the autonomous container.

FIG. 2 shows a plan view of the autonomous container.

FIG. 3 shows a front view of the autonomous container.

FIG. 4 shows a side view of the autonomous container.

FIG. 5 shows a back view of the autonomous container.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

We claim:

1. A modular autonomous container capable of delivering itself via a road system without the need of a semi-truck, trailer, or driver which is powered by rechargeable batteries comprising of the following:
a. A shipping container;
b. A 3-wheeler pallet;
c. A 4-wheeler pallet:
d. A rechargeable battery;
e. A computing device; and
f. A plurality of wheels;

2. The modular autonomous container capable of delivering itself via a road system without the need of a semi-truck, trailer, or driver which is powered by rechargeable batteries as in claim 1, wherein the autonomous container consists of the shipping container.

3. The shipping container as in claim 2, wherein the shipping container is powered by the rechargeable battery;

4. The shipping container as in claim 2, wherein the direction and speed of the autonomous container is controlled by the computing device;

5. The shipping container as in claim 2, wherein the plurality of wheels are powered by the rechargeable battery;

6. The modular autonomous container capable of delivering itself via a road system without the need of a semi-truck, trailer, or driver which is powered by rechargeable batteries as in claim 1, wherein the autonomous container consists of the 3-wheeler pallet.

7. The three-wheeler pallet as in claim 6, wherein the three-wheeler pallet is powered by the rechargeable battery.

8. The three-wheeler pallet as in claim 6, wherein the direction and speed of the autonomous container is controlled by the computing device;

9. The three-wheeler pallet as in claim 6, wherein the plurality of wheels are powered by the rechargeable battery.

10. The modular autonomous container capable of delivering itself via a road system without the need of a semi-truck, trailer, or driver which is powered by rechargeable batteries as in claim 1, wherein the autonomous container consists of a 4-wheeler pallet.

11. The four-wheeler pallet as in claim 10, wherein the four-wheeler pallet is powered by the rechargeable battery;

12. The four-wheeler pallet as in claim 10, wherein the direction and speed of the autonomous container is controlled by the computing device;

13. The four-wheeler pallet as in claim 10, wherein the plurality of wheels are powered by the rechargeable battery.
